(19) United States
(12) Patent Application Publication
(10) Pub. No.: US 2026/0300390 A1
(43) Pub. Date: Oct. 1, 2026

(54) METHOD FOR VIDEO SEARCHING

(71) Applicant: O Sparks Affiliate Media Group Holdings Limited, Taipei City (TW)

(72) Inventor: Shr Jin Christopher WEI, Arlington, TX (US)

(73) Assignee: O Sparks Affiliate Media Group Holdings Limited, Taipei City (TW)

(21) Appl. No.: 19/701,025

(22) Filed: Jun. 8, 2026

Related U.S. Application Data
(63) Continuation-in-part of application No. 18/924,889, filed on Oct. 23, 2024, now Pat. No. 12,670,210.

(30) Foreign Application Priority Data
Mar. 18, 2024 (TW) 113109961

(51) Int. Cl. G06F 16/73; G06F 16/71; G06F 16/783

(52) U.S. Cl. CPC G06F 16/73; G06F 16/71; G06F 16/7844

(57) ABSTRACT

A method for video searching is implemented using a server having access to a plurality of video files. For each video file, the server constructs a hierarchical content index including at least a first index level and a second index level. A user search query is converted to a searching word embedding and matched against word embeddings of tag words associated with content objects at a designated level of a hierarchy, and a video segment delimited by a matched content object's timestamp dataset is returned to the user without any separate timestamp lookup operation or post-retrieval segment assembly, regardless of whether the video file is stored locally or hosted remotely.

### CROSS-REFERENCE TO RELATED APPLICATION

This is a continuation-in-part application of U.S. patent application Ser. No. 18/924,889, filed on Oct. 23, 2024, which claims priority to Taiwanese Invention Patent Application No. 113109961, filed on Mar. 18, 2024. The entire content of each of the U.S. and Taiwanese patent applications is incorporated herein by reference.

### FIELD

The disclosure relates to a method for content searching, and more particularly to a method for video searching that employs a hierarchical content index of timestamped content objects organized at multiple levels of granularity.

### BACKGROUND

In the field of content search, the application of searching for videos based on search queries has become very common. Conventionally, video search engines or systems that are commercially available are configured to implement video searching by comparing the search queries inputted by the user and, for each of a number of videos stored in a video database, a title and a number of tags associated with the video. When the comparison yields one or more videos that match the search queries, the video search engines then return the one or more videos to the user.

It is noted that in the case that the search queries inputted by the user aren't accurate enough, which may result from the user being unsure of the content of the video he/she is searching for, the resulting video(s) that match(es) the search queries may not be actually what the user is looking for.

A fundamental limitation of these conventional systems is that search results identify videos as whole units. A user whose query matches content appearing at a specific point within a long video must either watch the entire video or manually navigate through the video to find the relevant portion.

More recently, some approaches have employed techniques such as transcript-based search, where textual transcripts of video content, derived from subtitle files or speech recognition, are indexed and searched to identify relevant passages. These systems are configured to identify the approximate position of relevant content within a video through the timestamps naturally associated with transcript segments. However, such systems employ a two-phase retrieval architecture: in the first phase, a search mechanism operating on textual features identifies a matching transcript passage; and in the second phase, a separate lookup is performed to resolve the timestamps associated with the matching transcript passage and to assemble a video segment for presentation. The timestamps are extrinsic to the searchable index; they reside in a separate data structure and are consulted only after a match has already been found through a mechanism that operates without reference to temporal boundaries. This two-phase architecture means that a granularity of the returned video segment is fixed by the chunking of the underlying transcript: the system returns whatever chunk matched, and when a user desires a segment at a different level of granularity, a post-retrieval aggregation step must stitch transcript chunks together after the fact.

A further limitation of the conventional systems is that all indexed content objects reside in a single level of granularity. A user who wants a broad conceptual overview of a video's major topic and a user who wants to locate a precise statement made in a specific moment of the same video are both served by the same retrieval mechanism operating on the same content objects. This single-level approach does not reflect the natural hierarchical structure of information; the fact that a video includes major thematic sections, which in turn includes more granular informational highlights, are themselves derived from the verbatim transcript.

### SUMMARY

There is therefore a need for a video search method that: (a) indexes video content at multiple levels of granularity corresponding to a natural hierarchical structure of information; (b) computes and stores, at an index construction time, a timestamp dataset for each content object at every level, such that the timestamp dataset is stored as structural property of the content object rather than metadata resolved at query time; (c) allows a user to designate or derive an appropriate level of search precision for a given query; and (d) returns, upon matching a content object, a specific video segment delimited by the content object's pre-computed timestamp dataset as an immediate consequence of the match, without any post-retrieval timestamp resolution or segment assembly step.

Therefore, an object of the present disclosure is to provide a method for video searching that employs a hierarchical content index of timestamped content objects. The hierarchical content index includes at least a first index level and a second index level. Each of the first index level and the second index level includes independently searchable content objects. Each content object stores a timestamp dataset that includes a starting timestamp and an ending timestamp as a structural field computed during an index construction. When a search query matched against a content object yields the temporally delimited video segment defined by that content object's stored timestamp dataset without any separate timestamp lookup operation.

According to one embodiment of the disclosure, the method is implemented using a server storing a plurality of video files. For each of the plurality of video files, the server constructs a hierarchical content index that includes at least a first index level and a second index level. The first index level includes a plurality of first-level content objects. Each of the plurality of first-level content objects is associated with a portion of a video file and stores a first-level timestamp dataset including a starting timestamp and an ending timestamp indicating temporal boundaries of the portion within the video file. The second index level includes a plurality of second-level content objects derived from content of the first index level. Each second-level content object is associated with one or more of the first-level content objects and stores a second-level timestamp dataset computed during the construction of the hierarchical content index by deriving the temporal boundaries from the timestamps of the associated first-level content objects.

In embodiments, each content object at each level of the hierarchical content index is represented by a word embedding that encodes semantic content of the object. In response to receipt of a search query, the server converts the search query to a searching word embedding and matches the searching word embedding against the word embeddings of content objects at a designated hierarchical level to identify the most semantically similar content object, and the video segment delimited by the stored timestamp dataset of the matched content object is returned to the user without any separate timestamp lookup.

In some embodiments, the hierarchical content index is constructed by: (a) obtaining a subtitle file associated with the video file, the subtitle file including verbatim transcript text with associated per-segment timestamps, the subtitle file content objects constituting the first index level; (b) processing the subtitle file using a language processing module to generate a plurality of highlight summaries, each of the plurality of highlight summaries indicating the semantic content of a highlighted portion of the subtitle file, and computing and storing a highlight timestamp dataset for each of the plurality of highlight summaries by deriving temporal boundaries from the per-segment timestamps associated with segments of the subtitle file constituting the highlighted portion, the highlight summaries and corresponding timestamp datasets constituting the second index level; and (c) for each of the plurality of highlight summaries at the second index level, generating one or more tags using the language processing module, each tag serving as a searchable tag word associated with the highlight summary, and obtaining a word embedding for each tag.

In some embodiments, additional index levels of the hierarchical content index may be constructed above the first index level and the second index level. By way of non-limiting illustration, a third index level may be constructed by processing two or more highlight summaries using the language processing module to generate a plurality of chapter-level summaries, each of the plurality of chapter-level summaries storing a chapter timestamp dataset computed during the construction of the hierarchical content index by deriving the temporal boundaries from the timestamps of the constituent highlight summaries. Additional levels of semantic abstraction may be constructed in the same manner, each level being derived from content at the level immediately below it and storing a timestamp dataset computed at construction time from the temporal boundaries of its constituent lower-level content objects.

One effect of the disclosure is that the method returns to the user not a video file as a whole, but a specific timestamped video segment that is defined by a starting timestamp and an ending timestamp and that is the content object matched by the search query. This enables the user to be navigated directly to the precise portion of a video relevant to their search intent without viewing the entire video.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a server for implementing a method for video searching according to one embodiment of the disclosure.

FIG. 2 is a flow chart illustrating steps of an exemplary search setup procedure to process video files according to one embodiment of the disclosure.

FIGS. 3 and 4 are flow charts illustrating steps of an exemplary video searching procedure according to one embodiment of the disclosure.

FIG. 5 is a block diagram illustrating a server, a user device, and a remote video server according to one embodiment of the disclosure.

FIG. 6 is a flow chart illustrating steps of a hierarchical content index construction procedure for processing video files according to one embodiment of the disclosure.

FIG. 7 is a diagram illustrating a hierarchical content index structure showing a relationship between a subtitle file, a highlight, a plurality of content objects and chapter levels, each content object storing a timestamp dataset as a structural field computed during the hierarchical content index construction.

FIG. 8 is a flow chart illustrating steps of a video searching procedure wherein a search query is matched against content objects at a designated hierarchical level and a video segment delimited by the matched content object's stored timestamp dataset is returned without any separate timestamp lookup operation.

FIG. 9 is a flow chart illustrating steps of a cross-language video searching procedure incorporating language-family detection and differential co-occurrence retrieval within a hierarchical content index framework.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

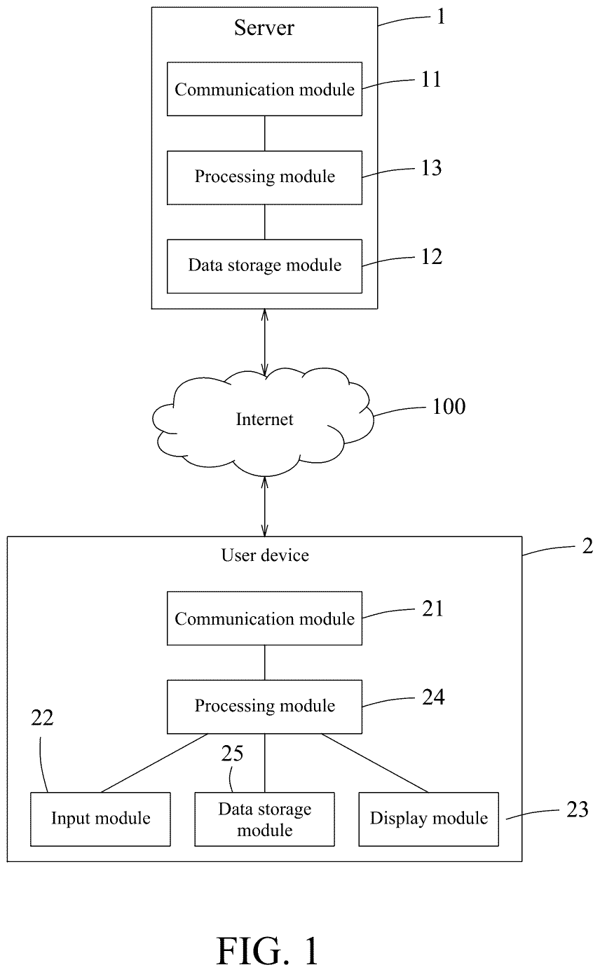

FIG. 1 is a block diagram illustrating a server 1 for implementing a method for video searching according to one embodiment of the disclosure. In this embodiment, the server 1 may be connected to a user device 2 via a network (e.g., the Internet 100). It is noted that while in the embodiment of FIG. 1, one user device 2 is present, in other embodiments, additional user device(s) 2 may be present and connected to the server 1 simultaneously.

The server 1 may be embodied using a video server, a personal computer, or other suitable equipment. The server 1 includes a communication module 11, a data storage module 12, and a processing module 13.

The communication module 11 is connected to the processing module 13, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or the fifth generation (5G) of wireless mobile telecommunications technology, or the like. The communication module 11 enables the server 1 to communicate with the user device 2.

The data storage module 12 is connected to the processing module 13, and may be embodied using, for example, one or more of random access memory (RAM), read only memory (ROM), programmable ROM (PROM), firmware, flash memory, etc. In this embodiment, the data storage module 12 stores a software application that includes instructions that, when executed by the processing module 13, cause the processing module 13 to implement the operations as described below. In embodiments, the data storage module 12 may store an operating system that is adapted for a video hosting platform and that enables the server 1 to run the video hosting platform. The video hosting platform may include a search function that enables users to attempt to search the video hosting platform for videos.

In embodiments, the data storage module 12 further stores a plurality of video files, a plurality of tag datasets that are associated with the plurality of video files, respectively, a plurality of tag words that are in a natural language, a plurality of word embeddings that correspond with the tag words, respectively, and, with respect to each of the tag words, a plurality of co-occurrences that are associated with the tag word. Typically, each of the word embeddings is in the form of a vector. The term “co-occurrences” may be referred to as words that each are likely to appear adjacent to the associated one of the tag words. Generally, a frequency of the co-occurrence appearing in a text file is positively related to a frequency of the associated one of the tag words appearing in the same text file. In this embodiment, each of the co-occurrences may also serve as a tag word.

Each of the tag datasets includes one or more of tags that each correspond with the entirety or a video segment of the associated video file. In some embodiments, the video file includes a plurality of video segments, and each of the tag datasets includes at least one tag for each of the video segments. Each of the tags may also serve as a tag word. In some embodiments, each of the tag words is in a first language family, and has a number of co-occurrences that are in the first language family (referred to as first language family co-occurrences) and a number of co-occurrences that are in languages not in the first language family (referred to as non-first language family co-occurrences). In some embodiments, with respect to each of the tag words, the co-occurrences associated with the tag word may be sorted based on a co-occurring frequency with the tag word.

The processing module 13 may be embodied using one or more of a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The user device 2 may be held by and operated by a user, and may be embodied using a personal computer, a laptop, a tablet, a smartphone, or other suitable equipment. The user device 2 includes a communication module 21, an input module 22, a display module 23, a processing module 24, and a data storage module 25.

The communication module 21, the data storage module 25, and the processing module 24 may be embodied using components similar to the communication module 11, the data storage module 12, and the processing module 13, respectively. The input module 22 may be embodied using a keyboard/mouse. The display module 23 may be embodied using a display screen, a touchscreen, etc. In some embodiments, the input module 22 and the display module 23 may be integrated using a touchscreen.

In use, it may be beneficial for the server 1 to first process the video files stored in the data storage module 12 to enable a more efficient search function. As such, the processing module 13 may be configured to implement a search setup procedure to process the video files.

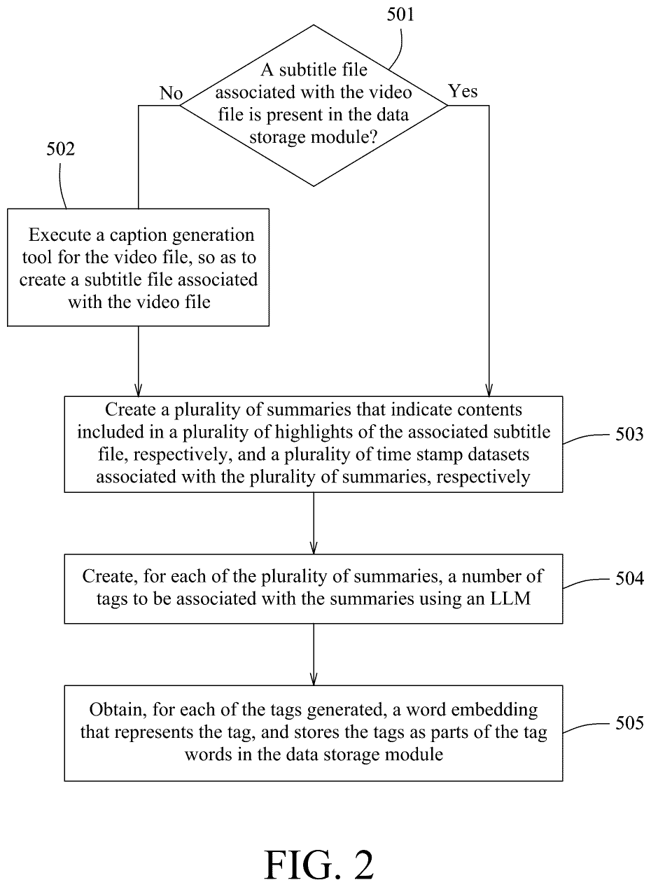

FIG. 2 is a flow chart illustrating steps of an exemplary search setup procedure to process the video files according to one embodiment of the disclosure. In the embodiment of FIG. 2, the search setup procedure is implemented using the server 1 shown in FIG. 1.

In step 501, for each of the video files stored in the data storage module 12, the processing module 13 determines whether a subtitle file associated with the video file is present in the data storage module 12. In embodiments, the subtitle file may be in the format of a SubRip subtitle file or other suitable formats. In the case that it is determined that no subtitle file associated with the video file is present, the flow proceeds to step 502. Otherwise, the flow proceeds to step 503. It is noted that in embodiments, the subtitle file may be obtained using a web crawler tool or uploaded by a user. Typically, after the operations of step 501, a plurality of video files that are without associated subtitle files may be detected.

In step 502, the processing module 13 executes a caption generation tool for the video file, so as to create a subtitle file associated with the video file. It is noted that the caption generation tool may be embodied using commercially available software, and details thereof are omitted herein for the sake of brevity.

In step 503 (i.e., in the case that each of the video files has an associated subtitle file), the processing module 13 creates, for each of the video files with an associated subtitle file, a plurality of summaries that indicate contents included in a plurality of highlights of the associated subtitle file, respectively, and a plurality of time stamp datasets associated with the plurality of summaries, respectively. Each of the time stamp datasets may include a starting time stamp and an ending time stamp that indicate a start and a finish of a corresponding one of the highlights of an associated subtitle file (and in turn, the video file). It is noted that the term “highlight” may refer to a specific section of the subtitle file that corresponds with one video segment of the associated video file, and each of the summaries is also associated with one of the video segments of the associated video file. The operations of step 503 may be done by feeding the video file into a large language model (LLM) as an input, and the summaries and the time stamp datasets may be generated as an output.

In step 504, the processing module 13 creates, for each of the plurality of summaries, a number of tags to be associated with the summaries. The operations of step 504 may be done by feeding the summaries into the LLM as an input, and the number of tags may be generated as an output.

In embodiments, the operations of steps 503 and 504 may be done by invoking an application programming interface (API) to communicate with a generative artificial intelligence (AI) model (e.g., the OpenAI Chat completion API or other commercially available models), and to input a prompt to cause the generative AI model to create the summaries and the tags. One exemplary prompt in the first language family may be “please generate a plurality of highlights from the subtitle file, and a summary for each of the highlights; then, please generate a number of tags for each of the summaries”. In other embodiments, the tags may be manually inputted by other users accessing the video hosting platform.

In step 505, the processing module 13 obtains, for each of the tags generated in step 504, a word embedding that represents the tag, and stores the tags as parts of the tag words in the data storage module 12.

In embodiments, the operations of step 505 may be done by invoking another API (e.g., the OpenAI Embeddings API or other suitable tools) to obtain the word embedding for each of the tags. Alternatively, the operations of step 505 may be done by using another LLM to obtain the word embedding for each of the tags.

As such, the search setup procedure is completed and the quantity of tag words increases as more video files are being processed.

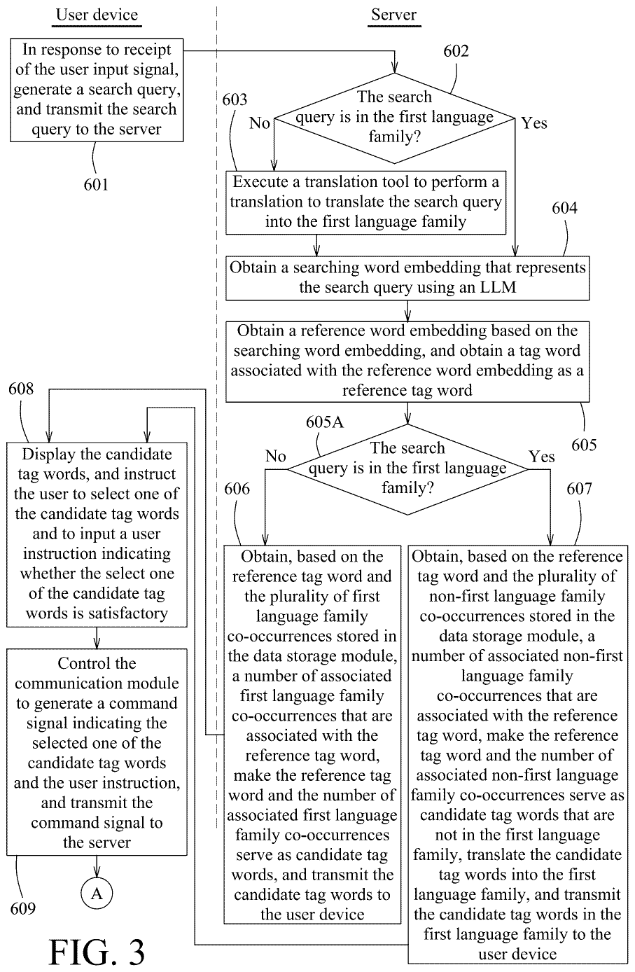

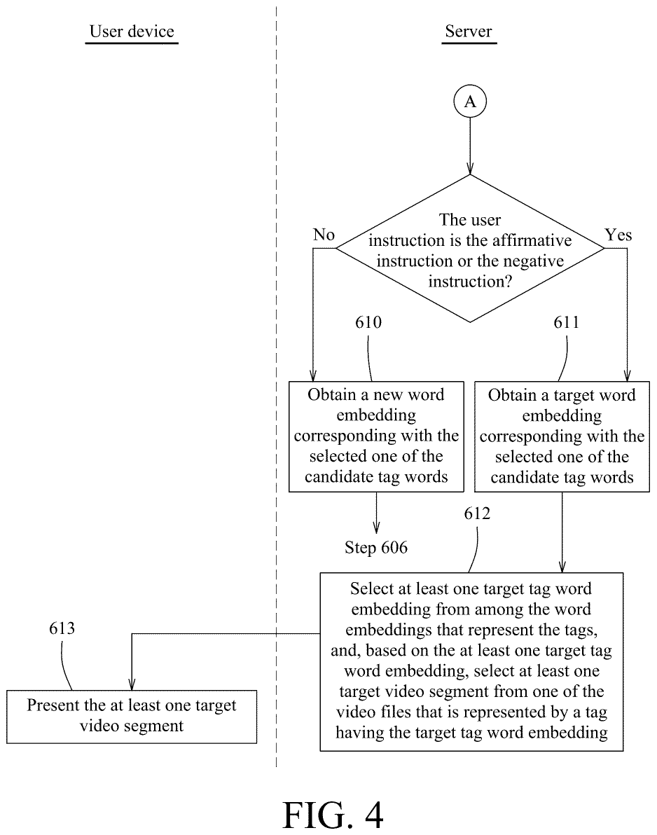

After the search setup procedure is completed, a user operating the user device 2 may attempt to search for videos using the video hosting platform, so as to initiate a video searching procedure. FIGS. 3 and 4 are flow charts illustrating steps of an exemplary video searching procedure according to one embodiment of the disclosure. In the embodiment of FIGS. 3 and 4, the video searching procedure may be implemented using the server 1 of FIG. 1.

In step 601, the user operates the input module 22 of the user device 2 to access the video hosting platform, and inputs a user input signal (by using an interface such as a keyboard or a virtual keyboard displayed on the touchscreen). In response to receipt of the user input signal, the processing module 24 generates a search query, and controls the communication module 21 to transmit the search query to the server 1.

In embodiments, the search query is in the form of a string of text in a natural language, and may or may not be in the first language family (which may be Mandarin or English).

In step 602, in response to the receipt of the search query, the processing module 13 determines whether the search query is in the first language family. In the case that the search query is in the first language family, the flow proceeds to step 604. Otherwise, the flow proceeds to step 603.

In step 603, the processing module 13 executes a translation tool to perform a translation to translate the search query into the first language family. In embodiments, the operations of step 603 may be done by executing a commercially available translation tool (e.g., Google Translate™ or other suitable tools).

In step 604, the processing module 13 obtains a searching word embedding that represents the search query. In embodiments, the operations of step 604 may be done using a manner similar to that of step 505. That is, the operations of step 604 may be done by invoking another API (e.g., the OpenAI Embeddings API or other suitable tools) to obtain the searching word embedding for the search query. Alternatively, the operations of step 604 may be done by using another LLM to obtain the searching word embedding.

In step 605, the processing module 13 obtains a reference word embedding based on the searching word embedding, and obtains a tag word associated with the reference word embedding as a reference tag word.

Specifically, in this embodiment, the processing module 13 calculates a similarity (e.g., the cosine similarity) between the searching word embedding and each of the word embeddings stored in the data storage module 12, and one of the word embeddings that is stored in the data storage module 12 and that has the highest similarity with the searching word embedding is selected as the reference word embedding.

It is noted that in some embodiments, the processing module 13 obtains a plurality of reference word embeddings (each having a similarity with the searching word embedding that is higher than a predetermined threshold) based on the searching word embedding, and makes, for each of the reference word embeddings, a corresponding tag word serve as a reference tag word, which generates a plurality of reference tag words.

Then, in step 605A, the processing module 13 determines whether the search query is in the first language family. In the case that the search query is in the first language family, the flow proceeds to step 606. Otherwise, the flow proceeds to step 607.

In step 606, the processing module 13 obtains, based on the reference tag word and the plurality of first language family co-occurrences stored in the data storage module 12, a number of associated first language family co-occurrences that are associated with the reference tag word, makes the reference tag word and the number of associated first language family co-occurrences serve as candidate tag words, and controls the communication module 11 to transmit the candidate tag words to the user device 2.

It is noted that in the embodiments where a plurality of reference tag words are obtained in step 605, the operations of step 606 may include repeating the above operations with respect to each of the reference tag words to obtain the number of associated first language family co-occurrences, to make all the reference tag words and the associated first language family co-occurrences for all of the reference tag words serve as candidate tag words, and to control the communication module 11 to transmit the candidate tag words to the user device 2.

In step 607, the processing module 13 obtains, based on the reference tag word and the plurality of non-first language family co-occurrences stored in the data storage module 12, a number of associated non-first language family co-occurrences that are associated with the reference tag word, makes the reference tag word and the number of associated non-first language family co-occurrences serve as candidate tag words that are not in the first language family, translates the candidate tag words into the first language family, and controls the communication module 11 to transmit the candidate tag words in the first language family to the user device 2.

It is noted that in the embodiments where a plurality of reference tag words are obtained in step 605, the operations of step 607 may include repeating the above operations with respect to each of the reference tag words to obtain the number of associated non-first language family co-occurrences, making all the reference tag words and all the number of associated non-first language family co-occurrences serve as candidate tag words that are not in the first language family, translating the candidate tag words into the first language family, and controlling the communication module 11 to transmit all the candidate tag words to the user device 2.

It is noted that in the embodiment of FIGS. 3 and 4, the generation of the candidate tag words is done based on the language of the search query, and both the first language family co-occurrences and the non-first language family co-occurrences are stored in the data storage module 12 to achieve a higher predicting accuracy for the candidate tag words. In other embodiments, the data storage module 12 may store additional co-occurrences in additional language families for an even higher predicting accuracy.

In step 608, in response to receipt of the candidate tag words, the processing module 24 controls the display module 23 to display the candidate tag words, and instruct the user to select one of the candidate tag words and to input a user instruction indicating whether the select one of the candidate tag words is satisfactory. For example, the instruction “Please select one of the following tag words that is the closest to what you are looking for, and indicate whether the selected tag word is satisfactory or not” may be displayed on the display module 23. In use, the display module 23 may be controlled to display two additional buttons (e.g., Yes and No), the user input of the “Yes” button indicates an affirmative instruction (i.e., the select one of the candidate tag words is satisfactory), and the user input of the “No” button indicates a negative instruction (i.e., the select one of the candidate tag words is not satisfactory).

Then, after the user operates the input module 22 to select one of the candidate tag words and to input the user instruction, in step 609, in response to receipt of the selected one of the candidate tag words and the user instruction, the processing module 24 controls the communication module 21 to generate a command signal indicating the selected one of the candidate tag words and the user instruction, and transmits the command signal to the server 1.

In step 609A, in response to the receipt of the command signal, the processing module 13 determines whether the user instruction is the affirmative instruction or the negative instruction.

In the case that the user instruction is the affirmative instruction, the flow proceeds to step 611. Otherwise (the user instruction is the negative instruction), the flow proceeds to step 610. It is noted that in some cases, the user may be satisfied with one of the candidate tag words that is not identical to the reference tag word.

In step 610, in response to the negative instruction, the processing module 13 obtains a new word embedding corresponding with the selected one of the candidate tag words. In embodiments, the operations of step 610 may be implemented using a manner similar to that of step 604. Then, the flow goes back to step 606 to obtain a new set of candidate tag words, and to subsequently present the new set of candidate tag words for the user to select. It is noted that in embodiments, such loop may be repeated for a number of times, and the selection of the selected one of the candidate tag words in each time may be recorded and stored in the data storage module 12 for further data processing.

In step 611, in response to the receipt of the affirmative instruction, the processing module 13 obtains a target word embedding corresponding with the selected one of the candidate tag words. In embodiments, the operations of step 611 may be done using a manner similar to that of step 505.

In step 612, the processing module 13, based on the target word embedding obtained in step 611, selects at least one target tag word embedding from among the word embeddings that represent the tags, and, based on the at least one target tag word embedding, selects at least one target video segment from one of the video files that is represented by a tag having the target tag word embedding.

Specifically, in this embodiment, the processing module 13 calculates a similarity (e.g., the cosine similarity) between the target word embedding and each of the word embeddings stored in the data storage module 12, and one of the word embeddings that is stored in the data storage module 12 and that has the highest similarity with the target word embedding is selected as the target tag word embedding. Alternatively, in some embodiments, the processing module 13 obtains a plurality of target tag word embeddings (each having a similarity with the target word embedding that is higher than a predetermined threshold). Then, the processing module 13 determines, for each of the target tag word embeddings, the tag represented by the target tag word embedding, and then determines the target video segment of one of the video files that is represented by the tag.

Then, in step 613, the processing module 13 controls the communication module 11 to transmit the at least one target video segment to the user device 2, so as to enable the processing module 24 to present the at least one target video segment on the display module 23 for the user. It is noted that in the case that multiple target video segments are determined in step 612, the processing module 24 may present a thumbnail of each of the target video segments on the display module 23 for the user to select one of the target video segments to watch.

To sum up, embodiments of the disclosure provide a method for video searching. In the method, a search setup procedure is first implemented to process the video files stored in a server. The search setup procedure involves using a LLM to, for each of the video files with an associated subtitle file, generate a plurality of summaries that indicate the contents included in a plurality of highlights of the associated subtitle file, respectively, and a plurality of time stamp datasets that are associated with the plurality of summaries, respectively, wherein the highlight is a specific section of the associated subtitle file that corresponds with one video segment of the associated video file.

Then, after a user operates a user device to initiate a video searching procedure, the server receiving a search query is configured to first obtain a searching word embedding that represents the search query, obtain a reference word embedding based on the searching word embedding, and obtain a tag word associated with the reference word embedding as a reference tag word. Then, based on a language family of the search query, the server obtains a number of associated co-occurrences that are associated with the reference tag word, and transmits the reference tag word and the number of associated co-occurrences to the user device as candidate tag words. In turn, the user may be enabled to select one of the candidate tag words which may better represent his/her intention for searching. In this manner, at least one target video segment that reflects a more accurate result of the search may be selected and presented to the user.

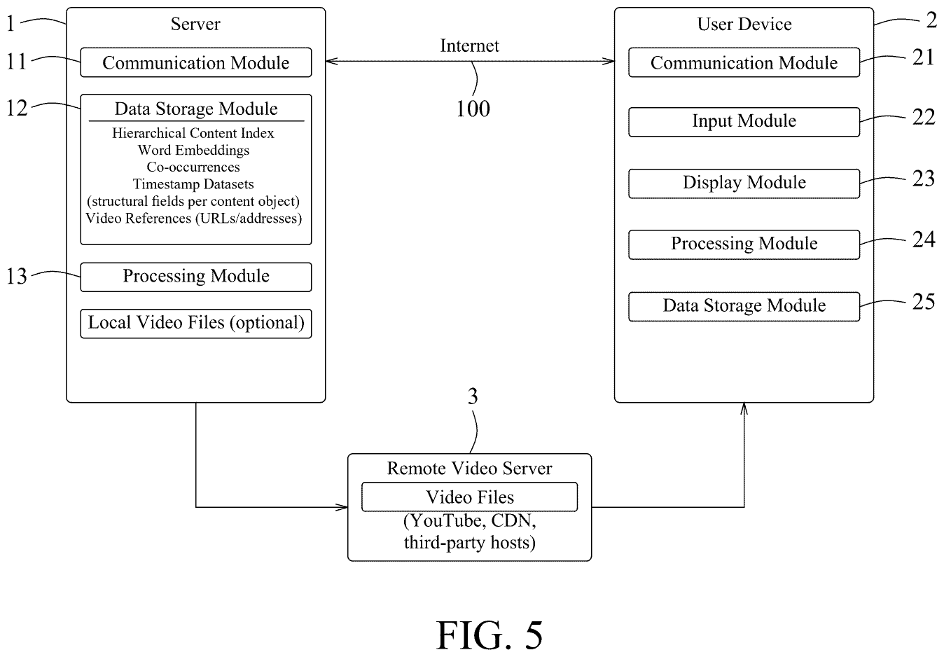

FIG. 5 is a block diagram illustrating a system for implementing the method according to one embodiment of the disclosure. The system includes a server 1 that is connected to a user device 2 and at least one remote video server 3 via a network (e.g., the Internet 100). The server 1 includes a communication module 11, a data storage module 12, and a processing module 13. The user device 2 may be embodied using a personal computer, a laptop, a tablet, a smartphone or other suitable electronic devices, and includes a communication module 21, an input module 22, a display module 23, a processing module 24, and a data storage module 25. Each remote video server 3 hosts one or more video files accessible to the server 1 via the network. While in the embodiment of FIG. 5, only one remote video server 3 is present, in other embodiments, additional remote video server(s) 3 may be present.

The data storage module 12 of the server 1 stores, for each of a plurality of video files, a hierarchical content index that includes a plurality of index levels, a plurality of word embeddings that correspond to content objects at each level of the hierarchical content index, and a plurality of co-occurrences that are associated with each of the content objects. Each of the index levels includes a plurality of content objects. Each of the content objects stores a timestamp dataset that includes a starting timestamp and an ending timestamp as a structural field of the content object's record. The plurality of video files may be stored locally in the data storage module 12, or may be hosted on the remote video server 3 accessible to the server 1 via the network, or a combination thereof. In embodiments where a video file is hosted on the remote video server 3, the data storage module 12 further stores a video reference identifying a remote location of the video file (e.g., a URL, an API endpoint, or other network-accessible addresses) in association with the hierarchical content index for the video file. The data storage module 12 may further store software configured for running a video hosting platform including a search function enabling users to search for videos using a method described herein. It is noted that the hierarchical content index, the word embeddings, the co-occurrences, and the timestamp datasets are stored on the server 1 regardless of whether the underlying video file is stored locally or hosted remotely; that is, the content index is independent of a physical location of the video file.

A central technical feature of the disclosure is the hierarchical content index (hierarchy). The hierarchical content index organizes information content of a video file into a plurality of index levels of increasing semantic abstraction (hierarchical level). Specifically, each of the index levels includes a plurality of content objects. Each of the content objects stores a timestamp dataset including a starting timestamp and an ending timestamp as a structural field of the content object record. The timestamp datasets are computed and stored during construction of the hierarchical content index, such that temporal boundaries of a corresponding video segment are a persistence storing a property of the content object, rather than metadata resolved at query time. Each of the content objects at each of the index levels is represented by a word embedding that encodes its semantic content and enables semantic similarity matching against search queries. The content objects at higher index levels of the hierarchy are derived from the content objects at lower index levels, and the timestamp datasets thereof are computed during construction of the hierarchical content index by deriving temporal boundaries from constituent content objects included in lower index levels.

The hierarchical structure of the hierarchical content index reflects the natural organization of information in video content of the video file. Typically, a video file includes a plurality of major thematic sections (which may be referred to herein as “chapters” by way of illustration). Each of the chapters includes a plurality of more granular informational highlights, and each of the highlights corresponds to one or more verbatim transcript segments derived from a subtitle file associated with the video file. Each level of this hierarchical structure provides a different level of search precision; broader levels enable users to find general thematic section that is most relevant to their search query, while finer levels enable users to locate the specific moment within the video file in which a particular statement or concept is discussed.

It is noted that while the terms “subtitle level,” “highlight level,” and “chapter level” are used herein for purposes of illustration, the disclosure is not limited to any particular number of levels or any particular terminology for the levels. The hierarchical content index may include any number of levels (e.g., at least two), constructed as described herein, and the terms used to describe the levels are illustrative rather than limiting.

A fundamental architectural distinction between the present disclosure and the prior art systems lies in when and how timestamp datasets are determined. In conventional transcript-based search systems, the search index and the temporal boundary data are maintained as separate data structures. The conventional transcript-based search system searches an index of textual features, identifies a match, and then performs a separate lookup operation against a distinct timestamp store to resolve the temporal position of the matched text within the video. The timestamp is extrinsic to the searchable object; it is resolved at query time, and is not committed to the searchable object at construction time. If the user requests a video segment having a granularity different from the chunking applied to the underlying transcript, for example, a thematic summary spanning multiple transcript chunks, the conventional transcript-based search system has to perform a post-retrieval aggregation step that assembles a video segment from multiple matched chunks after the fact. The temporal boundaries of the result are not known until this assembly is completed.

In the present disclosure, by contrast, each content object at every level of the hierarchical content index stores a timestamp dataset, which includes a starting timestamp and an ending timestamp, as a structural field of the content object record itself, and the timestamp dataset is computed and stored during index construction rather than being resolved at query time. Higher-level content objects (e.g., highlight-level or chapter-level content objects) derive their timestamp datasets from their constituent lower-level content objects during the index construction procedure. Specifically, the starting timestamp of a higher-level content object is set to the earliest starting timestamp among its constituent lower-level objects, and the ending timestamp is set to the latest ending timestamp among them. This derivation is performed once at construction time, and the resulting timestamp dataset is stored as a persistent field of the higher-level content object. Because the timestamp dataset is a stored structural property of each content object, when a search query is matched against a content object at any level of the hierarchy, the retrieval of the corresponding video segment, delimited by the starting timestamp and ending timestamp stored in the matched content object's record, is an immediate consequence of the match. No separate timestamp lookup operation or post-retrieval segment assembly step is required.

This architectural distinction has concrete consequences for multi-granularity retrieval. In conventional systems, serving a search at a different granularity requires either maintaining a separate search index for each desired granularity or performing runtime aggregation to assemble a segment spanning multiple matched chunks. In the present disclosure, because each content object at each hierarchical level has already stored its own pre-computed timestamp dataset, the system serves searches at any level of the hierarchy using the same retrieval mechanism: matching against content objects at the selected level, reading the timestamp dataset from the matched content object's record, and returning the video segment so delimited. The level of temporal precision is determined by which level of the hierarchy is selected for matching, and no runtime aggregation or timestamp resolution is needed regardless of the level selected. A match at the subtitle level returns the fine-grained video segment corresponding to a single verbatim transcript passage. A match at the highlight level returns a broader segment corresponding to a thematically coherent summary. A match at the chapter level returns a still broader segment corresponding to a major thematic section. In each case, the returned segment's temporal boundaries are read directly from the stored timestamp dataset of the matched content object.

Because each content object at every level of the hierarchical content index stores its own pre-computed timestamp dataset as a structural field, the same retrieval mechanism may be applied to one or more levels of the hierarchy concurrently in response to a single search query. In some embodiments, the processing module selects a plurality of search levels from among the index levels and matches the searching word embedding against the content objects at each of the plurality of selected search levels, thereby identifying, at each selected level, at least one matched content object and the video segment delimited by the starting timestamp and the ending timestamp stored in that matched content object's timestamp dataset. The plurality of selected search levels may be designated by the user device, inferred by the processing module from properties of the search query, or determined according to a default policy. Because the timestamp dataset of each matched content object at each selected level has already been committed to storage during construction of the hierarchical content index, the video segments identified at the plurality of selected search levels are each obtained by reading the stored timestamp dataset of the corresponding matched content object, without any runtime aggregation of lower-level content objects to derive the temporal boundaries of a higher-level segment and without any separate timestamp lookup operation. The video segments so identified at different levels of granularity may be returned together, for example as a set of results of differing temporal scope corresponding to the same search query, enabling a single query to be served simultaneously at multiple levels of granularity through one pass over the pre-constructed hierarchical content index. It is noted that this flexible matching capability is enabled by the construction-time commitment of per-level timestamp datasets described herein and does not depend upon the particular manner in which the plurality of search levels is designated.

It is noted that the hierarchical content index of the disclosure is not merely convenience optimization in which pre-existing timestamp data is cached for faster access. Rather, the timestamp datasets at higher levels of the hierarchy do not exist in the source material and cannot be derived by trivial operations on the underlying transcript. The subtitle file associated with a video file contains per-segment timestamps at the verbatim transcript (subtitle) level only. The timestamp datasets at and above the highlight level are created as part of the index construction procedure by a language processing module that may be embodied using an LLM executed by the processing module 13, that identifies thematically coherent groupings of lower-level content objects and that derives temporal boundaries for each grouping. The temporal boundaries of a highlight-level content object, specifically, which subtitle segments belong together as a thematically coherent unit, and therefore where the highlight begins and ends is determined by semantic analysis performed by the language processing module, instead of by mechanical subdivision or fixed-duration chunking. Without the semantic grouping step, the higher-level timestamp datasets do not exist. The hierarchical content index therefore creates new searchable content objects at multiple levels of granularity, each with its own semantically determined temporal boundaries, enabling a retrieval architecture in which the user's choice of search level determines the granularity of the returned video segment through a single retrieval mechanism operating on pre-constructed content objects, rather than through post-retrieval assembly of lower-level results.

The architecture of the disclosure as shown in FIG. 5 produces concrete improvements to the processing efficiency of a video search system. In conventional two-phase retrieval systems, every search query requires operations: (a) a first database operation to search a text-feature index and identify a match; (b) a second database operation to look up the timestamps associated with the matched text from a separate data structure; and, if multi-granularity retrieval is desired, (c) one or more additional database operations and CPU-intensive runtime aggregation steps to assemble a video segment spanning multiple matched chunks. The hierarchical content index as described in the disclosure eliminates operations (b) and (c) completely. Because the timestamp dataset is a structural field of the content object record, retrieval of the temporal boundaries requires only reading a field from the same record that was already accessed during the matching step, and no secondary database lookup against a distinct timestamp store is required. Because the content objects in each of the hierarchical levels have already stored pre-computed timestamp datasets derived at construction time, no runtime aggregation or segment assembly is required regardless of the search level selected. This reduction in per-query database operations, elimination of secondary lookups, and removal of runtime aggregation steps result in reduced query latency, fewer database read operations per query, and lower CPU overhead during the retrieval phase, representing a concrete technical improvement to the functioning of the video search system.

It is further noted that the architecture of the disclosure represents a deliberate design trade-off relative to conventional systems. Conventional systems that maintain timestamps as extrinsic metadata in a separate data structure, resolved at query time rather than committed at construction time, do so in part because this late-binding approach preserves flexibility. The system can dynamically re-chunk or re-aggregate transcript segments at runtime to serve different query granularities without modifying the stored index. The disclosure trades this runtime flexibility for construction-time commitment to level-specific temporal boundaries. By computing and storing the timestamp dataset as a structural field of each content object during index construction, the system commits to a specific set of temporal boundaries for each content object at each hierarchical level. This commitment enables the elimination of runtime timestamp resolution and segment assembly, but it means that the temporal boundaries of each content object are fixed at construction time and determined by the semantic grouping performed by the language processing module during index construction. This architectural choice, which is construction-time commitment over runtime flexibility, is the foundation of the processing efficiency improvements described herein and distinguishes the present disclosure from prior art systems that maintain extrinsic timestamps precisely to preserve runtime chunking flexibility.

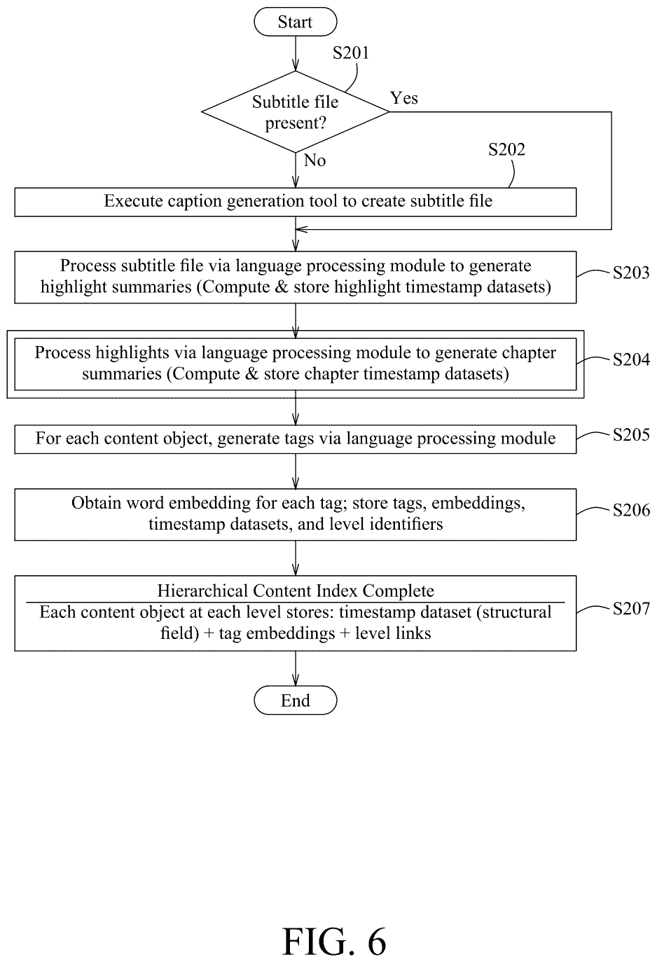

FIG. 6 is a flow chart illustrating steps of a hierarchical content index construction procedure according to one embodiment of the disclosure. The hierarchical content index procedure is implemented by the processing module 13 of the server 1 to process each of the video files stored in the data storage module 12.

In step S201, for each of the video files stored in the data storage module 12, the processing module 13 determines whether a subtitle file associated with the video file is present. In some embodiments, the subtitle file may be in the format of a SubRip (.srt) file, a WebVTT (.vtt) file, or other suitable subtitle formats. The subtitle file includes a plurality of subtitle segments, and each of the subtitle segments includes verbatim transcript text associated with a time-coded timestamp indicating when that text is spoken in the video contained in the video file. Each subtitle segment, together with its associated timestamp, constitutes a first-level content object in the hierarchical content index (e.g., the subtitle level) providing the most granular and verbatim representation of the video's content with the finest temporal precision. In a case where a subtitle file associated with the video file is not present, the flow proceeds to step S202. Otherwise, the flow directly proceeds to step S203.

In step S202, in a case where no subtitle file is present, the processing module 13 executes a caption generation tool for the video file so as to create a subtitle file associated with the video file. The caption generation tool may be embodied using commercially available speech-to-text software. After step S202, the flow proceeds to step S203.

In step S203, the processing module 13 processes the subtitle file, which is either stored in the data storage module 12 or created in step S202, using a language processing module to generate a plurality of highlight summaries and a plurality of highlight timestamp datasets that are respectively associated with the plurality of highlight summaries. The plurality of highlight summaries indicate the semantic content of a plurality of highlighted portions of the subtitle file. Each highlighted portion corresponds to a thematically coherent section of the subtitle file. The plurality of highlight timestamp datasets are associated with the plurality of highlight summaries, respectively. Each of the plurality of highlight timestamp datasets includes a starting timestamp and an ending timestamp computed by deriving temporal boundaries from the timestamps of the associated subtitle segments. Each highlight summary, together with an associated highlight timestamp dataset, is stored as a second-level content object in the hierarchical content index (e.g., the highlight level). The highlight timestamp dataset is stored as a structural field of the content object record at index construction time. It is noted that the term “highlight” refers to a specific section of the subtitle file that corresponds to one video segment of the associated video file.

In step S204, in embodiments where a third index level is required, the processing module 13 processes two or more of the highlight summaries using the language processing module to further generate a plurality of chapter-level summaries. Each of the chapter-level summaries indicates the overarching theme or topic of a plurality of thematically related highlight summaries, and stores a chapter timestamp dataset computed during index construction by setting the starting timestamp and the ending timestamp of the chapter timestamp dataset respectively to the earliest starting timestamp and the latest ending timestamp among the associated thematically related highlight summaries. Each of the chapter-level summaries, together with its stored chapter timestamp dataset, constitutes a third-level content object in the hierarchical content index (e.g., the chapter level). The chapter level provides a higher-order semantic abstraction above the highlight level, enabling search at a coarser level of thematic granularity. It is noted that step S204 is optional and that the hierarchical content index may include only the subtitle level and the highlight level, or may include additional levels higher than the chapter level constructed by further language-model-based abstraction from content at the immediately lower level. That is, in some embodiments, the flow may proceed from step S203 directly to step S205.

In step S205, the processing module 13 creates, for each content object at each level of the hierarchical content index (with the exception, in embodiments, of verbatim subtitle segments that can be indexed directly), a number of tags to be associated with the content object. Specifically, the tags respectively for the content objects are generated using the language processing module. The language processing module receives the text of summary of the content object as an input and generates a plurality of natural-language tags representing content such as key concepts, topics, entities, and themes discussed in the corresponding video segment.

In step S206, the processing module 13 obtains, for each tag generated in step S205, a word embedding that represents the tag, and stores the tags (as parts of the tag words), together with the associated word embeddings, timestamp datasets, and level identifiers (which identify a level of the hierarchy) in the data storage module 12. The word embeddings may be obtained by invoking an embedding API (e.g., a commercially available embedding model) or by using another language model. Each word embedding is in the form of a vector in a high-dimensional semantic space such that semantically similar concepts are represented by embeddings having high cosine similarity. At this stage, the construction of the hierarchical content index is completed.

Then, in step S207, the processing module 13 stores a multi-level index of the video content in the data storage module 12. Specifically, each of the content objects at each level is associated with a timestamp dataset including a starting timestamp and an ending timestamp as a structural field of its record. The timestamp dataset is computed and stored during construction of the hierarchical content index. Additionally, each of the content objects at each level is represented by one or more tags, each tag having an associated word embedding. Moreover, each of the content objects at each level is linked to content objects at adjacent levels of the hierarchy. The number of indexed content objects and their associated word embeddings increases as more video files are processed.

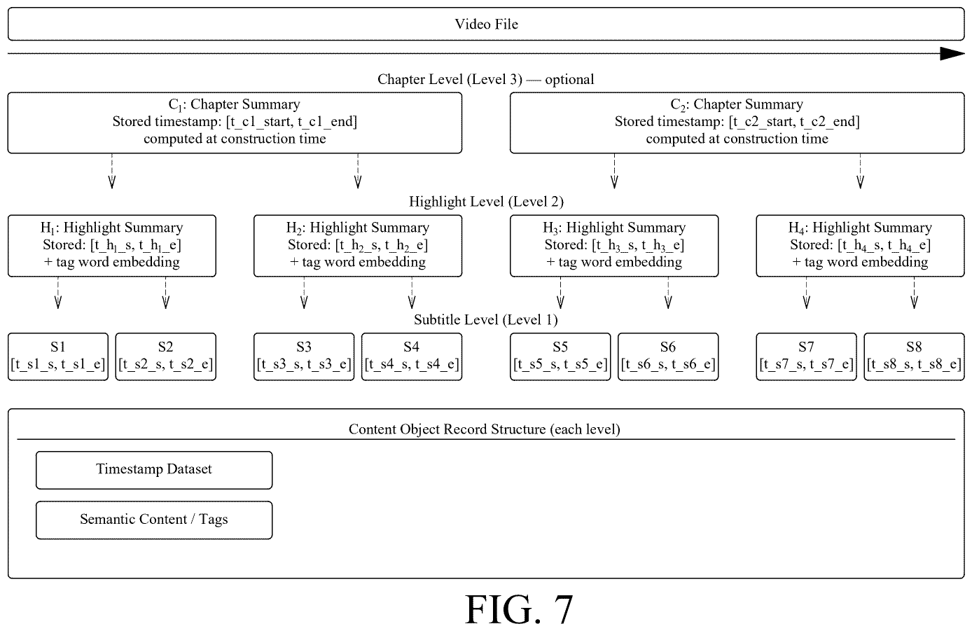

FIG. 7 illustrates the structure of the hierarchical content index for an exemplary video file. At the lowest level of the hierarchy (the subtitle level), the hierarchical content index includes a plurality of verbatim subtitle segments S₁, S₂, . . . , Sₙ (i.e., the first-level content objects), each including a fine-grained timestamp dataset [t_{si_start}, t_{si_end}]. At the second level (the highlight level), the hierarchical content index includes a plurality of highlight summaries H₁, H₂, . . . , Hₘ (i.e., the second-level content objects), each derived from a contiguous group of subtitle segments and including a highlight timestamp dataset [t_{hj_start}, t_{hj_end}] computed during index construction as [t_{si_start}, t_{sk_end}] where Sᵢ through Sₖ are the constituent subtitle segments. At an optional third level (the chapter level), the hierarchical content index includes a plurality of chapter summaries C₁, C₂, . . . , Cₚ (i.e., the third-level content objects), each derived from a group of thematically related highlights and storing a chapter timestamp dataset [t_{cl_start}, t_{cl_end}] computed during index construction from the constituent highlights.

Each of the content objects at and above the highlight level is associated with one or more tag words, and each tag word is associated with a word embedding. The word embeddings of the tag words constitute a searchable semantic index wherein a search query's word embedding is compared against the word embeddings of the tag words to identify the content object that is most semantically similar to the search query.

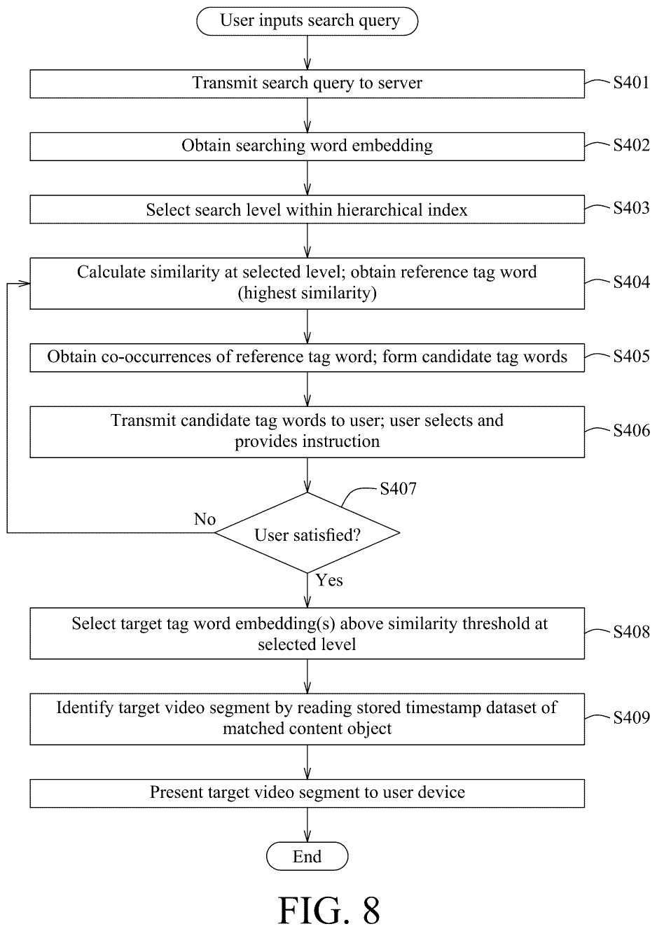

FIG. 8 is a flow chart illustrating steps of a video searching procedure according to one embodiment of the disclosure. After the hierarchical content index construction procedure is completed, a user operating the user device 2 may initiate a video searching procedure by inputting a search query through the input module 22.

In step S401, in response to receipt of a user input signal from the input module 22, the processing module 24 of the user device 2 generates a search query in natural language and controls the communication module 21 to transmit the search query to the server 1.

In step S402, in response to receipt of the search query, the processing module 13 of the server 1 obtains a searching word embedding that represents the search query. In embodiments, the searching word embedding is obtained using a language processing module, for example by invoking an embedding API. The searching word embedding is a vector in the same high-dimensional semantic space as the word embeddings of the tag words stored in the data storage module 12 of the server 1.

In step S403, the processing module 13 of the server 1 selects a search level within the hierarchical content index against which the search query will be matched. In embodiments, the search level may be designated explicitly by the user through the user device 2 (e.g., the user selects “search by highlight” or “search by chapter”). In other embodiments, the search level may be inferred by the processing module 13 based on properties of the search query, such as query length, specificity, or the presence of level-indicating terms. In still other embodiments, the processing module 13 may execute the search at a default level and present results at adjacent levels as supplementary results.

In step S404, the processing module 13 of the server 1 obtains a reference word embedding based on the searching word embedding, and obtains a tag word associated with the reference word embedding as a reference tag word. Specifically, the processing module 13 calculates a similarity (e.g., the cosine similarity) between the searching word embedding and each of the word embeddings stored in the data storage module 12 at the search level, and selects the word embedding having the highest similarity with the searching word embedding as the reference word embedding. The tag word associated with the selected reference word embedding serves as the reference tag word. The reference tag word and the plurality of co-occurrences are then stored in the server 1.

In step S405, the processing module 13 of the server 1 obtains, based on the reference tag word and the plurality of co-occurrences stored in the server 1, a number of associated co-occurrences that are associated with the reference tag word, and makes the reference tag word and the number of associated co-occurrences serve as candidate tag words. The associated co-occurrences are words that are likely to appear adjacent to the reference tag word in text files, and their frequency of co-occurrence is positively related to the frequency of the reference tag word in the same text file.

In step S406, the processing module 13 of the server 1 transmits the candidate tag words to the user device 2. In response, the display module 23 of the user device 2 displays the candidate tag words and instructs the user to select one of the candidate tag words and to input a user instruction indicating whether the selected candidate tag word is satisfactory. The user instruction may be an affirmative instruction (the selected candidate tag word accurately represents the user's search intent) or a negative instruction (it does not represent the user's search intent).

In step S407, in response to receipt of a command signal indicating the selected candidate tag word and the user instruction, the processing module 13 of the server 1 obtains: (a) if the user instruction is affirmative, a target word embedding corresponding to the selected candidate tag word; or (b) if the user instruction is negative, a new word embedding corresponding to the selected candidate tag word and a new set of candidate tag words by repeating step S405, enabling the user to iteratively refine the search direction.

In step S408, the processing module 13 of the server 1, based on the target word embedding, selects at least one target tag word embedding from among the word embeddings at the search level that has a similarity to the target word embedding higher than a predetermined threshold. In embodiments, the processing module 13 may select a plurality of target tag word embeddings each having a similarity above the predetermined threshold, enabling presentation of multiple results ranked by semantic similarity.

In step S409, the processing module 13 of the server 1 selects, based on the at least one target tag word embedding, at least one target video segment from one of the plurality of video files. The target video segment is delimited by the starting timestamp and ending timestamp stored in the timestamp dataset of the matched content object at the search level. Because the timestamp dataset has been computed and stored during index construction, no separate timestamp lookup operation or post-retrieval segment assembly is required at this step. In embodiments where the video file is stored locally in the data storage module 12, the processing module 13 retrieves the target video segment directly. In embodiments where the video file is hosted on the remote video server 3, the processing module 13 obtains the video reference stored in association with the hierarchical content index for the video file and transmits the video reference together with the starting timestamp and ending timestamp to the user device 2, enabling the user device 2 to retrieve and present the target video segment from the remote video server 3. The processing module 24 controls the display module 23 to present the at least one target video segment to the user.

In some cases, the presenting the at least one target video segment includes transmitting to the user device the starting timestamp and ending timestamp stored in the timestamp dataset of the matched content object, and further includes, in a case where the video file is hosted on the remote video server 3, a video reference identifying the remote location of the video file, and enabling the user device to retrieve from the remote video server and present the precise temporal portion of the video file delimited by the matched content object's stored timestamp dataset without any separate timestamp resolution.

It is noted that because each content object stores its timestamp dataset as a structural field computed during index construction, the video segment returned to the user is determined entirely by reading the stored timestamp dataset of the matched content object, regardless of whether the underlying video file is stored locally on the server 1 or hosted on the remote video server 3. No separate timestamp resolution step or post-retrieval segment assembly step is required at query time. The user receives a video segment that begins at the starting timestamp and ends at the ending timestamp stored in the matched content object's record, presenting precisely the portion of the video corresponding to the user's search intent. The physical location of the video file, whether local or remote, does not affect the operation of the hierarchical content index or the retrieval of the temporally delimited video segment.

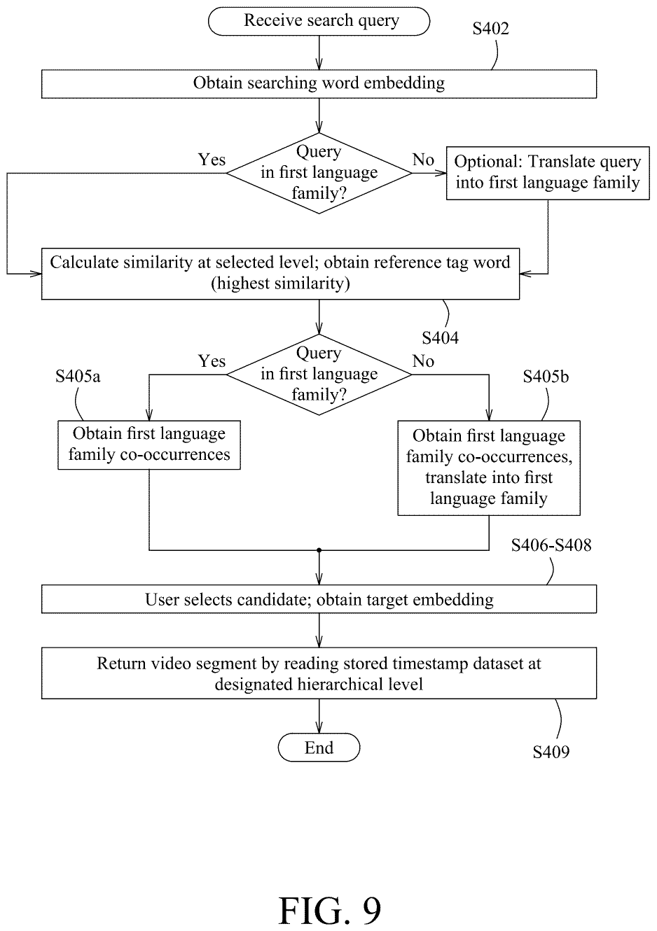

FIG. 9 is a flow chart illustrating a cross-language video searching procedure according to one embodiment of the disclosure, which incorporates the language-family-conditional co-occurrence retrieval architecture of the parent application (U.S. application Ser. No. 18/924,889) into the hierarchical content index framework of the disclosure. It is noted that the cross-language video searching procedure may be incorporated in the method for searching videos described in the previous embodiments.

In embodiments, each tag word in the hierarchical content index is in a first language family and has a number of first language family co-occurrences that are in the first language family and a number of non-first language family co-occurrences that are in languages not in the first language family. The first language family may be, by way of example, the Mandarin Chinese language family or the English language family.

After obtaining the searching word embedding in step S402, the processing module 13 determines whether the search query is in the first language family. In a case where the search query is not in the first language family, the processing module 13 may execute a translation tool to translate the search query into the first language family before obtaining the searching word embedding, or may proceed with cross-language matching as described below.

In step S405, the processing module 13 obtains co-occurrences differentially based on the language family of the search query. Specifically, in a case where the search query is in the first language family, the processing module 13 obtains, based on the reference tag word and the number of first language family co-occurrences, a number of associated first language family co-occurrences associated with the reference tag word, and makes the reference tag word and the number of associated first language family co-occurrences serve as the candidate tag words. Alternatively, in a case where the search query is not in the first language family, the processing module 13 obtains, based on the reference tag word and the number of non-first language family co-occurrences, a number of associated non-first language family co-occurrences associated with the reference tag word, makes the reference tag word and the number of associated non-first language family co-occurrences serve as the candidate tag words, and translates the candidate tag words into the first language family before transmitting the translated candidate tag words to the user device 2.

This cross-language capability ensures that users may initiate a search in any language and receive candidate tag words and video segments drawn from content indexed in the first language family, with automatic translation that preserves the user's experience regardless of the language of the search query. The combination of the cross-language search architecture and the hierarchical content index enables users to search across language boundaries at any designated level of the hierarchy.

In sum, embodiments of the disclosure provide a method for video searching wherein the hierarchical content index enables precision-controlled retrieval of timestamped video segments at multiple levels of semantic abstraction, and wherein each content object at every level of the hierarchy stores a pre-computed timestamp dataset as a structural field, enabling direct delivery of the specific video segment corresponding to the user's search intent without any separate timestamp lookup or post-retrieval segment assembly.

According to one embodiment of the disclosure, there is a method for video searching. The method is implemented using a server having access to a plurality of video files. The plurality of video files are stored locally on the server or hosted on one or more remote video servers accessible to the server via a network or a combination thereof. The server stores, for each of the plurality of video files, a hierarchical content index including at least a first index level and a second index level. The first index level includes a plurality of first-level content objects, each of the plurality of first-level content objects storing a first-level timestamp dataset as a structural field of a content object record. The first-level timestamp dataset includes a starting timestamp and an ending timestamp demarcating temporal boundaries of a corresponding video segment. The first-level timestamp dataset has been committed to storage during construction of the hierarchical content index. The second index level includes a plurality of second-level content objects. Each of the plurality of second-level content objects are derived from content of one or more of the plurality of first-level content objects by a language processing module and storing a second-level timestamp dataset as a structural field of the content object record. The second-level timestamp dataset has been computed during the construction of the hierarchical content index by setting a starting timestamp and an ending timestamp of the second-level timestamp dataset to an earliest starting timestamp and a latest ending timestamp of the one or more of the plurality of first-level content objects from which the second-level content object was derived. The second-level timestamp dataset has been committed to storage during the construction of the hierarchical content index. The hierarchical content index is structured such that, upon matching a search query to a content object at any level of a hierarchy, the video segment delimited by the starting timestamp and the ending timestamp stored in a matched content object's timestamp dataset is identifiable by reading the matched content object's timestamp dataset without performing any separate timestamp lookup operation on a distinct data structure or any post-retrieval segment assembly based on constituent lower-level content objects. The method includes:
a) in response to receipt of a search query from a user device, selecting a search level within the hierarchical content index to conduct a search, the search level being at least the second index level;
b) matching the search query against the content objects at the search level to identify a matched content object; and
c) identifying at least one target video segment from one of the plurality of video files by reading the starting timestamp and the ending timestamp stored in the matched content object's timestamp dataset, and presenting the at least one target video segment to the user device.

According to one embodiment of the disclosure, the first index level includes subtitle segments derived from a subtitle file associated with the one of the plurality of video files, each of the subtitle segments including verbatim transcript text of a portion of the one of the plurality of video files and storing an associated per-segment timestamp dataset as a structural field of its content object record. The plurality of second-level content objects are highlight summaries, each of which is derived from a plurality of contiguous subtitle segments by a language processing module, each of the highlight summaries storing a highlight timestamp dataset computed during index construction by deriving temporal boundaries from the plurality of constituent subtitle segments.

According to one embodiment of the disclosure, matching the search query against the content objects at the search level includes: obtaining a searching word embedding that represents the search query; calculating a similarity between the searching word embedding and word embeddings associated with the content objects at the search level to identify a reference tag word; determining whether the search query is in a first language family; in a case where the search query is in the first language family, obtaining, based on the reference tag word and a plurality of first language family co-occurrences stored in the server, a number of associated first language family co-occurrences, and making the reference tag word and the number of associated first language family co-occurrences serve as candidate tag words; and in a case where the search query is not in the first language family, obtaining, based on the reference tag word and a plurality of non-first language family co-occurrences stored in the server, a number of associated non-first language family co-occurrences, making the reference tag word and the number of associated non-first language family co-occurrences serve as the candidate tag words, and translating the candidate tag words into the first language family.

According to one embodiment of the disclosure, the method further includes, prior to step i): in a case where the search query is not in the first language family, executing a translation tool to translate the search query into the first language family before obtaining the searching word embedding.

According to one embodiment of the disclosure, the presenting the at least one target video segment includes transmitting, to the user device, the starting timestamp and the ending timestamp stored in the timestamp dataset of the matched content object, and, in a case where the one of the plurality of video files is hosted on the remote video server, a video reference identifying a remote location of the one of the plurality of video files, and enabling the user device to retrieve one of the plurality of video files from the remote video server and to present a precise temporal portion of the one of the plurality of video files delimited by the matched content object's timestamp dataset without any separate timestamp resolution.

According to one embodiment of the disclosure, there is provided another method for video searching. The method being implemented using a server having access to a plurality of video files. The plurality of video files being stored locally on the server or hosted on one or more remote video servers accessible to the server via a network or a combination thereof. The method includes:
constructing, for each of the plurality of video files, a hierarchical content index by:
   i) obtaining a subtitle file associated with the video file, the subtitle file including a plurality of subtitle segments each having verbatim transcript text and an associated per-segment timestamp, each of the plurality of subtitle segments together with the associated per-segment timestamp constituting a first-level content object in the hierarchical content index, the plurality of subtitle segments constituting a first index level of the hierarchical content index; and
   ii) processing the subtitle file using a language processing module to generate a plurality of highlight summaries, each of the plurality of highlight summaries indicating that semantic content of a highlighted portion of the subtitle file includes one or more contiguous subtitle segments, and computing and storing a highlight timestamp dataset, the highlight timestamp dataset including a starting timestamp derived from an earliest starting timestamp of the constituent subtitle segments and an ending timestamp derived from a latest ending timestamp of the constituent subtitle segments, each of the plurality of highlight summaries together with its stored highlight timestamp dataset constituting a second-level content object in the hierarchical content index, the plurality of highlight summaries and their associated stored highlight timestamp datasets constituting a second index level of the hierarchical content index;
receiving a search query from a user device;
selecting a search level within the hierarchical content index;
matching the search query against the content objects at the search level to identify a matched content object; and
presenting, to the user device, a target video segment delimited by the starting timestamp and the ending timestamp stored in a timestamp dataset of the matched content object, whereby the target video segment is identified and returned by reading a pre-computed timestamp dataset from a matched content object's record without any separate timestamp lookup operation or post-retrieval segment assembly.

According to one embodiment of the disclosure, the constructing the hierarchical content index further includes:
iii) processing two or more of the plurality of highlight summaries at the second index level using a language processing module to generate chapter-level summaries indicating an overarching theme of the processed highlight summaries, and computing and storing a chapter timestamp dataset for the chapter-level summary, the chapter timestamp dataset including a starting timestamp derived from an earliest starting timestamp and an ending timestamp derived from a latest ending timestamp of the processed highlight summaries, each of the chapter-level summaries together with its stored chapter timestamp dataset constituting a third-level content object, the chapter-level summaries and their stored chapter timestamp datasets constituting a third index level of the hierarchical content index.

According to one embodiment of the disclosure, the hierarchical content index includes at least three levels, and the method further includes receiving a level designation from the user device indicating a designated search level. The matching the search query includes matching against the content objects at the designated search level, whereby the user may select the level of temporal and semantic precision at which the search is conducted.

According to one embodiment of the disclosure, the method further includes, prior to step i), determining whether the subtitle file associated with the video file is present in the server, and in a case where no subtitle file is present, executing a caption generation tool for the video file to create the subtitle file associated with the video file.

According to one embodiment of the disclosure, the hierarchical content index includes at least three levels of granularity. The first index level content objects correspond to verbatim subtitle segments each of which stores a fine-grained per-segment timestamp dataset. The second index level content objects correspond to the plurality of highlight summaries, each of which stores the highlight timestamp dataset computed during index construction by deriving temporal boundaries from the constituent subtitle segments. The third index level content objects correspond to chapter summaries, each of which stores a chapter timestamp dataset computed during the index construction by deriving the temporal boundaries from the constituent highlight summaries; the hierarchical content index provides a spectrum of search precision from fine-grained verbatim retrieval to broad thematic retrieval, and a search at any level returns a video segment delimited by the pre-computed timestamp dataset stored in the matched content object without any post-retrieval timestamp resolution or segment assembly.

According to one embodiment of the disclosure, the selecting the search level includes selecting a plurality of search levels from among the index levels of the hierarchical content index, and matching the search query against the content objects at the search level includes matching the search query against the content objects at each of the plurality of selected search levels to identify, at each of the plurality of selected search levels, a matched content object. The presenting the target video segment includes identifying, at each of the plurality of selected search levels, a target video segment delimited by the starting timestamp and the ending timestamp stored in the timestamp dataset of the matched content object at that selected search level. Each target video segment is identified by reading the pre-computed timestamp dataset stored in the corresponding matched content object without any runtime aggregation of lower-level content objects to derive temporal boundaries of a higher-level segment and without any separate timestamp lookup operation, whereby a single search query is served at a plurality of levels of granularity through one pass over the hierarchical content index.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for video searching, the method being implemented using a server having access to a plurality of video files, the plurality of video files being stored locally on the server or hosted on one or more remote video servers accessible to the server via a network or a combination thereof, the server storing, for each of the plurality of video files, a hierarchical content index, the hierarchical content index including at least a first index level and a second index level,
the first index level including a plurality of first-level content objects, each of the plurality of first-level content objects storing a first-level timestamp dataset as a structural field of a content object record, the first-level timestamp dataset including a starting timestamp and an ending timestamp demarcating temporal boundaries of a corresponding video segment, the first-level timestamp dataset having been committed to storage during construction of the hierarchical content index,
the second index level including a plurality of second-level content objects, each of the plurality of second-level content objects being derived from content of one or more of the plurality of first-level content objects by a language processing module and storing a second-level timestamp dataset as a structural field of the content object record, the second-level timestamp dataset having been computed during the construction of the hierarchical content index by setting a starting timestamp and an ending timestamp of the second-level timestamp dataset to an earliest starting timestamp and a latest ending timestamp of the one or more of the plurality of first-level content objects from which the second-level content object was derived, the second-level timestamp dataset having been committed to storage during the construction of the hierarchical content index,
the hierarchical content index being structured such that, upon matching a search query to a content object at any level of a hierarchy, the video segment delimited by the starting timestamp and the ending timestamp stored in a matched content object's timestamp dataset is identifiable by reading the matched content object's timestamp dataset without performing any separate timestamp lookup operation on a distinct data structure or any post-retrieval segment assembly based on constituent lower-level content objects,
the method comprising:
a) in response to receipt of a search query from a user device, selecting a search level within the hierarchical content index to conduct a search, the search level being at least the second index level;
b) matching the search query against the content objects at the search level to identify a matched content object; and
c) identifying at least one target video segment from one of the plurality of video files by reading the starting timestamp and the ending timestamp stored in the matched content object's timestamp dataset, and presenting the at least one target video segment to the user device.

2. The method as claimed in claim 1, wherein:
the first index level includes subtitle segments derived from a subtitle file associated with the one of the plurality of video files, each of the subtitle segments including verbatim transcript text of a portion of the one of the plurality of video files and storing an associated per-segment timestamp dataset as a structural field of its content object record; and
the plurality of second-level content objects are highlight summaries, each of which is derived from a plurality of contiguous subtitle segments by a language processing module, each of the highlight summaries storing a highlight timestamp dataset computed during index construction by deriving temporal boundaries from the plurality of constituent subtitle segments.

3. The method as claimed in claim 1, wherein matching the search query against the content objects at the search level includes:
obtaining a searching word embedding that represents the search query;
calculating a similarity between the searching word embedding and word embeddings associated with the content objects at the search level to identify a reference tag word;
determining whether the search query is in a first language family;
in a case where the search query is in the first language family, obtaining, based on the reference tag word and a plurality of first language family co-occurrences stored in the server, a number of associated first language family co-occurrences, and making the reference tag word and the number of associated first language family co-occurrences serve as candidate tag words; and
in a case where the search query is not in the first language family, obtaining, based on the reference tag word and a plurality of non-first language family co-occurrences stored in the server, a number of associated non-first language family co-occurrences, making the reference tag word and the number of associated non-first language family co-occurrences serve as the candidate tag words, and translating the candidate tag words into the first language family.

4. The method as claimed in claim 3, further comprising, in a case where the search query is not in the first language family, executing a translation tool to translate the search query into the first language family before obtaining the searching word embedding.

5. The method as claimed in claim 1, wherein presenting the at least one target video segment includes transmitting, to the user device, the starting timestamp and the ending timestamp stored in the timestamp dataset of the matched content object, and, in a case where the one of the plurality of video files is hosted on the remote video server, a video reference identifying a remote location of the one of the plurality of video files, and enabling the user device to retrieve one of the plurality of video files from the remote video server and to present a precise temporal portion of the one of the plurality of video files delimited by the matched content object's timestamp dataset without any separate timestamp resolution.

6. A method for video searching, the method being implemented using a server having access to a plurality of video files, the plurality of video files being stored locally on the server or hosted on one or more remote video servers accessible to the server via a network or a combination thereof, the method comprising:
constructing, for each of the plurality of video files, a hierarchical content index by:
i) obtaining a subtitle file associated with the video file, the subtitle file including a plurality of subtitle segments each having verbatim transcript text and an associated per-segment timestamp, each of the plurality of subtitle segments together with the associated per-segment timestamp constituting a first-level content object in the hierarchical content index, the plurality of subtitle segments constituting a first index level of the hierarchical content index; and
ii) processing the subtitle file using a language processing module to generate a plurality of highlight summaries, each of the plurality of highlight summaries indicating semantic content of a corresponding highlighted portion of the subtitle file, the corresponding highlighted portion comprising one or more contiguous subtitle segments, and computing and storing a highlight timestamp dataset, the highlight timestamp dataset including a starting timestamp derived from an earliest starting timestamp of the constituent subtitle segments and an ending timestamp derived from a latest ending timestamp of the constituent subtitle segments, each of the plurality of highlight summaries together with its stored highlight timestamp dataset constituting a second-level content object in the hierarchical content index, the plurality of highlight summaries and their associated stored highlight timestamp datasets constituting a second index level of the hierarchical content index;
receiving a search query from a user device;
selecting a search level within the hierarchical content index, the search level being at least the second index level;
matching the search query against the content objects at the search level to identify a matched content object; and
presenting, to the user device, a target video segment delimited by the starting timestamp and the ending timestamp stored in a timestamp dataset of the matched content object, whereby the target video segment is identified and returned by reading a pre-computed timestamp dataset from a matched content object's record without any separate timestamp lookup operation or post-retrieval segment assembly.

7. The method as claimed in claim 6, wherein constructing the hierarchical content index further includes:
iii) processing two or more of the plurality of highlight summaries at the second index level using a language processing module to generate chapter-level summaries indicating an overarching theme of the processed highlight summaries, and computing and storing a chapter timestamp dataset for the chapter-level summary, the chapter timestamp dataset including a starting timestamp derived from an earliest starting timestamp and an ending timestamp derived from a latest ending timestamp of the processed highlight summaries, each of the chapter-level summaries together with its stored chapter timestamp dataset constituting a third-level content object, the chapter-level summaries and their stored chapter timestamp datasets constituting a third index level of the hierarchical content index.

8. The method as claimed in claim 7, wherein the hierarchical content index includes at least three levels, and the method further comprises receiving a level designation from the user device indicating a designated search level, wherein matching the search query includes matching against the content objects at the designated search level, and wherein a user selects a level of temporal and semantic precision at which a search is conducted.

9. The method as claimed in claim 6, further comprising, prior to step i):
determining whether the subtitle file associated with the video file is present in the server; and
in a case where no subtitle file is present, executing a caption generation tool for the video file to create the subtitle file associated with the video file.

10. The method as claimed in claim 6, wherein:
the hierarchical content index includes at least three levels of granularity; the first index level content objects correspond to verbatim subtitle segments each of which stores a fine-grained per-segment timestamp dataset;
the second index level content objects correspond to the plurality of highlight summaries, each of which stores the highlight timestamp dataset computed during index construction by deriving temporal boundaries from the constituent subtitle segments;
the third index level content objects correspond to chapter summaries, each of which stores a chapter timestamp dataset computed during the index construction by deriving the temporal boundaries from the constituent highlight summaries;
the hierarchical content index provides a spectrum of search precision from fine-grained verbatim retrieval to broad thematic retrieval, and a search at any level returns a video segment delimited by the pre-computed timestamp dataset stored in the matched content object without any post-retrieval timestamp resolution or segment assembly.

11. The method as claimed in claim 6, wherein:
the selecting the search level includes selecting a plurality of search levels from among the index levels of the hierarchical content index, and matching the search query against the content objects at the search level comprises matching the search query against the content objects at each of the plurality of selected search levels to identify, at each of the plurality of selected search levels, a matched content object; and
the presenting the target video segment includes identifying, at each of the plurality of selected search levels, a target video segment delimited by the starting timestamp and the ending timestamp stored in the timestamp dataset of the matched content object at that selected search level, each target video segment being identified by reading the pre-computed timestamp dataset stored in the corresponding matched content object without any runtime aggregation of lower-level content objects to derive temporal boundaries of a higher-level segment and without any separate timestamp lookup operation, whereby a single search query is served at a plurality of levels of granularity through one pass over the hierarchical content index.
